(19) United States
(12) Patent Application Publication
(10) Pub. No.: US 2016/0023335 A1
(43) Pub. Date: Jan. 28, 2016

(54) Confined Space Upright Cleco Plier

(71) Applicant: Christopher Michael Braun, Roseville, CA (US)

(72) Inventor: Christopher Michael Braun, Roseville, CA (US)

(21) Appl. No.: 14/337,541

(22) Filed: Jul. 22, 2014

(51) Int. Cl. B25B 31/00; B25B 7/02

(52) U.S. Cl. CPC B25B 31/005; B25B 7/02

(57) ABSTRACT

This invention relates to improvements made to the traditional cleco plier. The object of this invention shall be cleco pliers with handles that are more upright than the current cleco pliers in use. They will have an upright set of handles with the angle of the handles, relative to the horizontal workspace, to be between 70 and 140 degrees, versus the traditional handle axis angle that is between 15-45 degrees above the horizontal work space. The object of this invention may include ergonomic elements to assist in gripping the pliers, and a hook or loop at the end of one or both handles to allow the user to better grip the pliers with their thumb or fingers.

### BACKGROUND OF THE INVENTION

This invention relates to improvements to cleco pliers, used in aircraft and other vehicle manufacturing, similar to those cleco pliers found in U.S. Pat. Nos. “2,328,866” and “2,755,541”. This invention may fall within the following classifications and subclassifications: Class 007/125, Class 007/126, Class 29/268, and/or Class 81/304.

### DESCRIPTION OF THE PRIOR ART

In sheet metal fabrication and assembly, particularly in the area of aircraft manufacturing, it is frequently necessary for two metal parts to be temporarily joined together. Traditional cleco pliers (FIG. 1), similar to those found in U.S. Pat. Nos. 2,328,866 and 2,755,541, are used to install and remove temporary sheet metal fasteners, known as clecos (FIG. 2), similar to those in U.S. Pat. Nos. 2,136,875 and 8,534,651. Clecos are inserted in match drilled holes to temporarily hold two or more parts in place, so that riveting, drilling, sizing, cutting, fitting, filing, deburring, bending and other metal fabrication tasks may be accomplished with accuracy. The cleco is typically cylindrical in shape, and contains a plunger (3) at one end, with expandable prongs (4) on the opposing end, which are activated by an internal spring.

Traditional cleco pliers (FIG. 1), used to install and remove clecos, have changed very little since their introduction in the early 20^{th} century. Traditional cleco pliers have opposing handles (8) at one end for the user's hand (17), and are attached by a pivot (9). At the opposite side of the pivot (9) there are jaws (10), which engage the cleco when the pliers' jaws (10) are squeezed together. The jaws of the cleco pliers are composed of a concave, integral or attached, piece (11) on one jaw (10) of the pliers, and a C shaped, integral or attached, piece (12) on the opposing jaw (10) of the pliers. The concave attachment (11) on one jaw (10) rests against the cleco plunger (3), and depresses it when the user squeezes the pliers. At the same time, a C-shaped attachment (12) on the opposing jaw (10), catches a ridge (5) which wraps around the circumference of the cleco body (2), providing an opposing force. This causes the cleco (FIG. 2) to activate.

While durable, and cheap to produce, traditional cleco pliers (FIG. 1) put the user's hand, wrist, and arm, at an awkward angle relative to the cleco and work surface. This awkward angle is uncomfortable and inefficient in power transfer. The traditional cleco pliers do not take advantage of the natural movement or angle of the hand, wrist, and arm. As a result, over the course of repeated uses, this awkward position can cause fatigue, pain, and undue stress to body parts and aggravate repetitive stress injuries such as carpal tunnel syndrome and various forms of arthritis. This is because of an improper handle axis angle (15).

Aside from being inefficient and uncomfortable, the traditional cleco pliers handle axis angle (15) also makes it very difficult to engage the cleco in a confined space. The traditional handle axis angle is close to horizontal, relative to the work surface (16). As a result, the cleco pliers protrude out across the workspace inconveniently when the pliers engage the cleco. This presents challenges when attempting to insert and remove clecos where multiple parts or other clecos are present nearby. Inserting clecos near the intersection of two or more parts, can be impossible.

The handle axis (14) is a virtual axis solely created for the purpose of illustrating the difference between the traditional cleco pliers and the proposed Object of this Invention (FIG. 3). The handle axis (14) extends longitudinally down the length of the pliers' handles (8) from the user end through the pivot (9) connecting the two handles (8). The handle axis (14) is equilateral between the two handles (8) of both the traditional cleco plier (FIG. 1.) and the Object of this Invention (FIG. 3). The angle of the handle axis (14), the Handle Axis Angle (15), is again solely a virtual reference to illustrate the difference between the traditional pliers and the Object of this Invention. The handle axis angle (15) on traditional cleco pliers is approximately 15-45 degrees above, and relative to, the horizontal work surface (16) in which the cleco is being inserted. The proposed Object of this Invention moves the Handle Axis Angle (15) upward, so that it is more vertical and upright. The proposed Handle Axis Angle (15) on the Object of this Invention, will be located between 70 degrees and 140 degrees above, and relative to, the horizontal work surface (16), in which the cleco is inserted. This will make the handles (8) more upright and close to parallel to the cleco body (2), rather than being close to parallel with the horizontal work surface (16).

### SUMMARY OF THE INVENTION

It is an object of this invention, to provide cleco pliers with a more upright handle axis angle (FIG. 3.) that will be between 70 degrees and 140 degrees above, and relative to, the horizontal work surface in which the cleco is being inserted. Clecos (FIG. 2) are perpendicular, or vertical, relative to the horizontal surfaces being joined. If the cleco pliers handle axis angle is more upright and parallel relative to the cleco body, the body of the cleco pliers will take up less horizontal workspace and will be more compact. This will allow the user to install and remove clecos in more confined spaces with greater ease.

Another benefit of cleco pliers with a more upright handle axis angle, is that the cleco pliers will be more comfortable. A more upright handle axis angle allows a more natural hand movement. (Ref. FIG. 4) This will reduce strain and irritation of the muscles, tendons, nerves, and ligaments, and it will reduce fatigue and pain as the result of repetitive stress injuries, such as carpal tunnel syndrome and arthritis. Furthermore, the Object of this Invention (FIG. 3), will allow the user to exert more force on the cleco which will increase the efficiency of the tool.

### BRIEF DESCRIPTION OF SEVERAL VIEWS OF THE DRAWING

FIG. 1—Perspective of the Traditional Cleco Pliers superimposed over a protractor to illustrate handle axis angle between 15-45 degrees above, and relative to, the horizontal work surface in which the cleco is inserted.

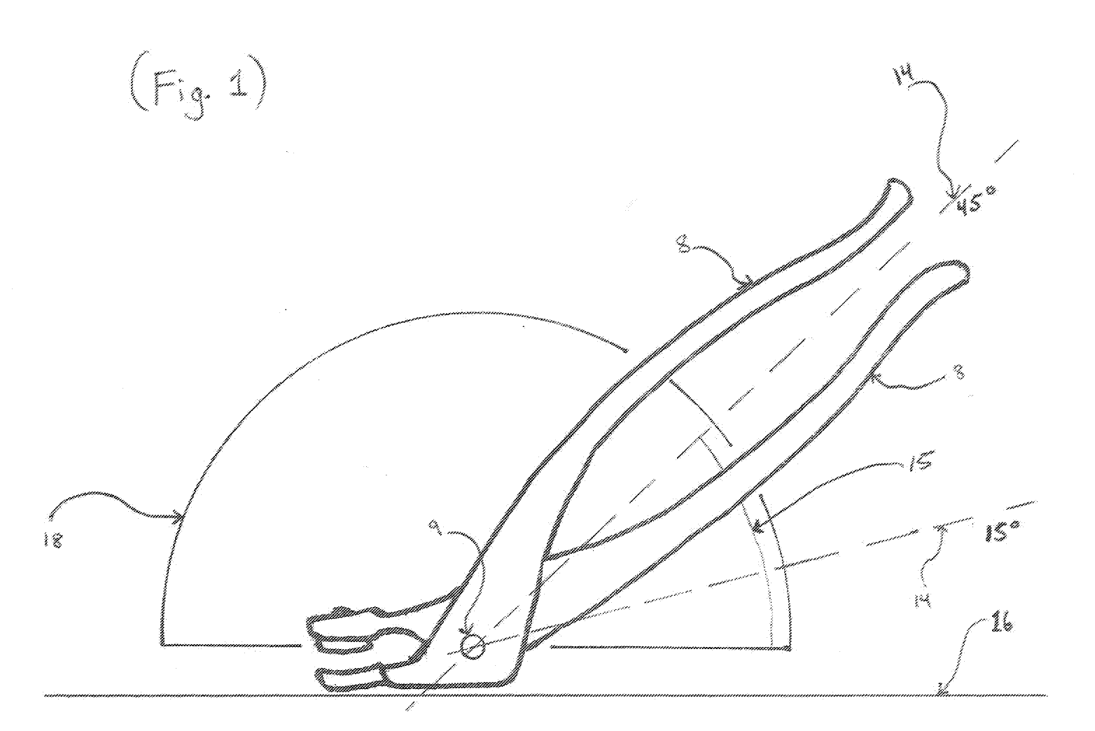

FIG. 2—Perspective of the Cleco

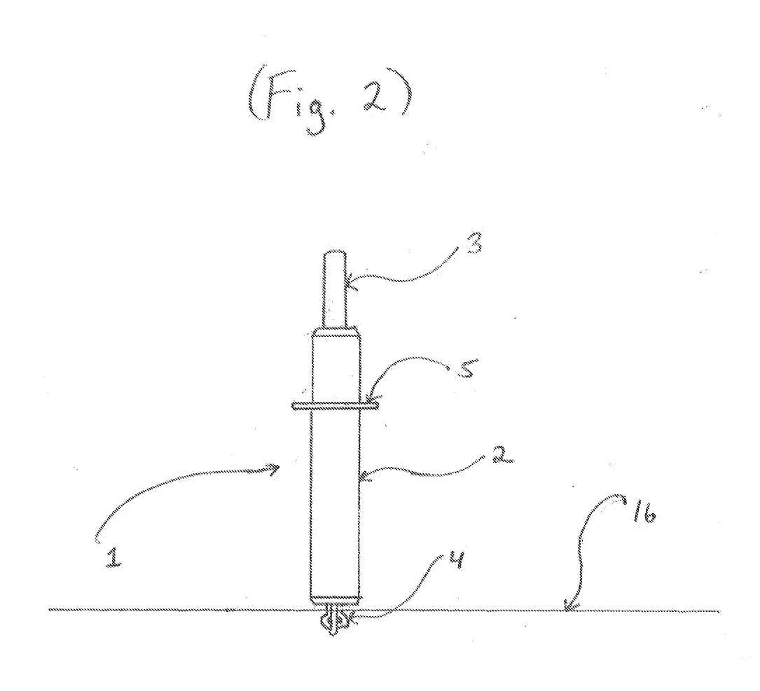

FIG. 3—Perspective of the object of this invention, Confined Space Upright Cleco Pliers, superimposed over a protractor to illustrate handle axis angle between 70-140 degrees above, and relative to, the horizontal work surface in which the cleco is inserted.

FIG. 4—Perspective of the Confined Space Upright Cleco Pliers, engaged by a user's hand.

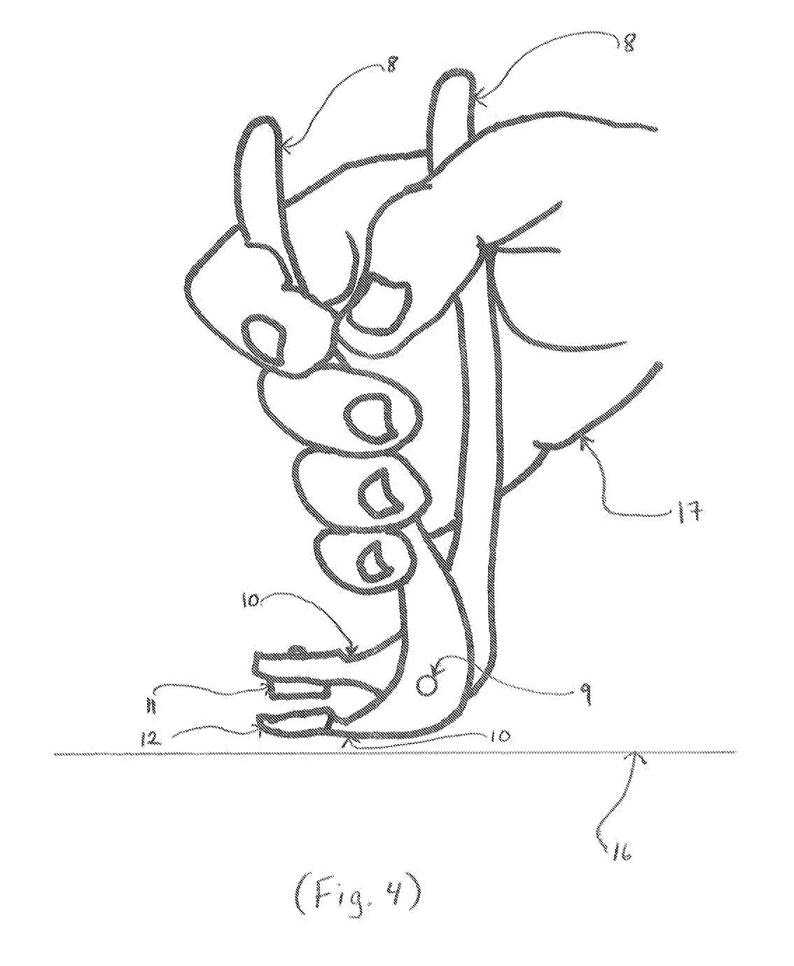

FIG. 5—Confined Space Cleco Pliers with Hand engaging Cleco pointing downward to the horizontal work surface.

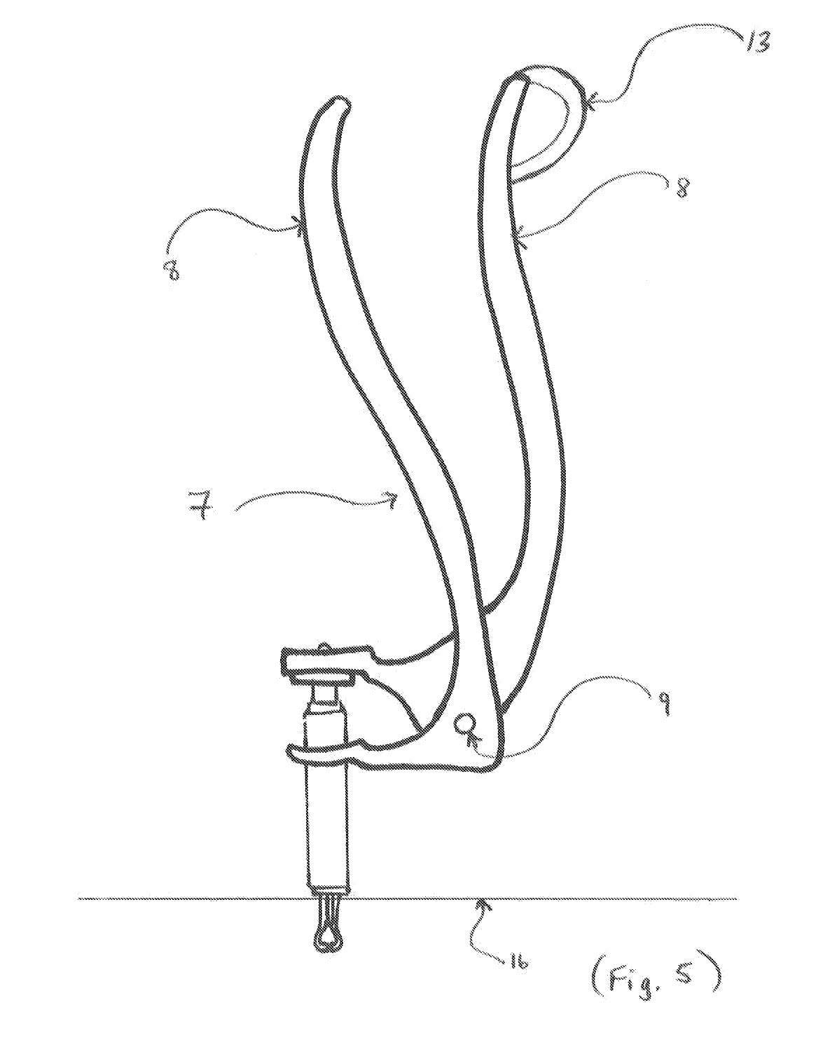

### NUMERICAL REFERENCES CONTAINED IN THE DRAWINGS

### 1. Cleco

2. Cleco body
3. Cleco plunger
4. Cleco prongs
5. Cleco ridge

### 6. Traditional Cleco Pliers

7. Object of this Invention—Confined Space Upright Cleco Pliers

### 8. Handle

### 9. Handle Pivot

### 10. Jaw

### 11. Concave Attachment

### 12. C-Shaped Attachment

13. Hook, Hole, or Protruding Piece on one or both Plier Handles

### 14. Handle Axis

### 15. Handle Axis Angle

### 16. Horizontal Work Surface

### 17. User's Hand

### 18. Virtual Protractor

### DETAILED DESCRIPTION OF THE INVENTION

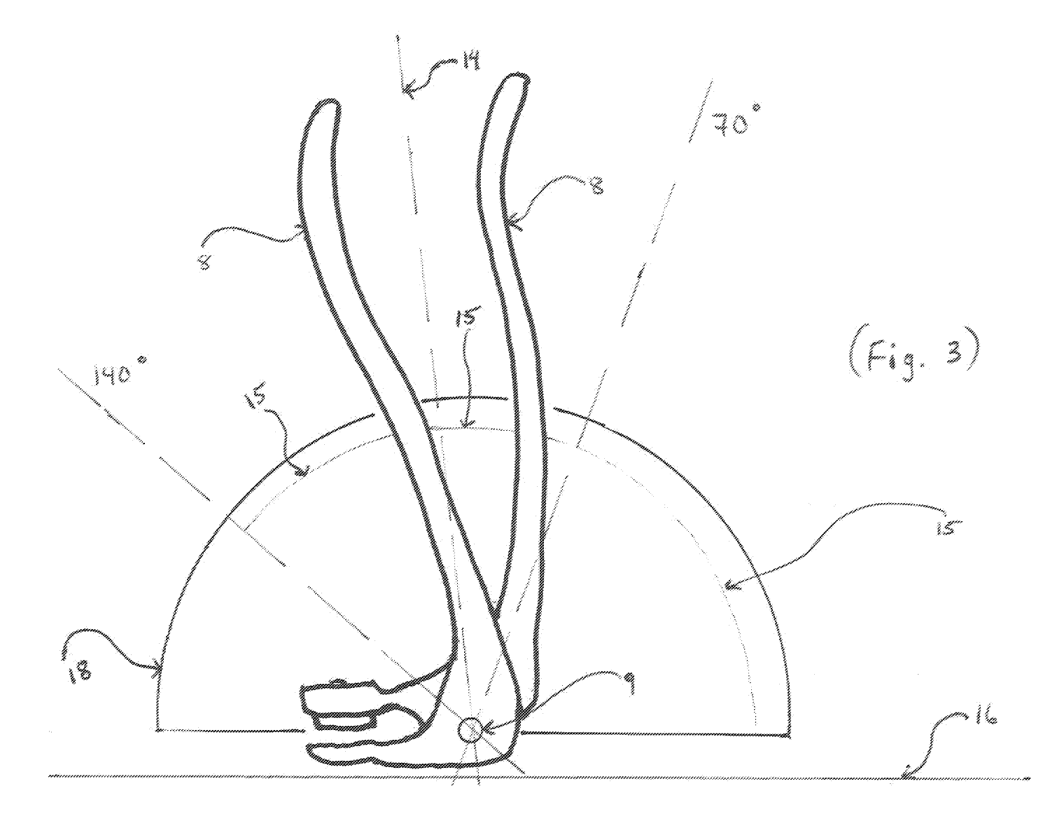

Referring to the drawings, the Object of this Invention is Confined Space Upright Cleco Pliers (FIG. 3) with a handle axis (14) that is positioned at a handle axis angle (15) within 70 degrees to 140 degrees above, and relative to, the horizontal work surface (16) in which the cleco (1) is inserted. The cleco pliers (6) have two opposing handles (8) at one end for the user's hand (16) attached by a pivot (9), and jaws (10) at the opposite end of the pivot (9) from the user's hand (16), which engage the cleco body (2) when the pliers' jaws (10) are squeezed together. The jaws (10) of the pliers are composed of a concave, integral or attached, piece (11) on one jaw (10) of the pliers, and a C shaped, integral or attached, piece (12) on the opposing jaw (10) of the pliers.

The concave attachment (11) on one jaw (10) rests against the cleco plunger (3) and depresses it when the user squeezes the pliers. At the same time, a C-shaped attachment (12) on the opposing jaw (10), catches a ridge (5) which wraps around the circumference of the cleco body (2), providing an opposing force. This causes the cleco (1) to activate.

The object of this invention will be constructed of, but not limited to, a metal, alloy, plastic, or composite substance. The object of this invention may be made by, but not limited to, casting, forging, or injection molding. The object of this invention may have bare handles or handles covered with a material to assist gripping, such as, but not limited to, rubber, plastic, or composite material. The object of this invention, may have ergonomic indentions for placement of fingers. The object of this invention may have an integral or attached hole, hook, or protruding piece on the end of one or both handles that will allow the user to hold the plier more effectively while in use, or when not in use.

Changes may be made in the embodiments of the invention described herein, or in the parts or the elements of the embodiments described herein or in the steps or sequence of steps of the methods described herein without departing from the spirit and/or scope of the invention as defined in the following claims.

I claim:

1. A cleco plier, with a handle axis angle found within 70 to 140 degrees above, and relative to, the horizontal work surface in which the cleco is placed.

2. A cleco plier, made up of:
a. Two opposing handles connected by a pivot, that move relative to one another;
i. Which may or may not be covered,
ii. and may or may not include shapes or indentions on the handle to facilitate comfort.
b. Two jaws on one end of the pivot, opposite of each other and placed on each handle, made up of:
i. an integral, or attached, flat or concave piece that will serve to contact the cleco plunger on one jaw and,
ii. on the opposite jaw, an integral or attached, C-shaped or semi-circle piece that will also contact the cleco.
c. An integral or attached hook, hole, or protruding piece on the user ends of one or both of the handles to enable the user to support the cleco pliers with their thumb or fingers during activation of the pliers, or when not in use.
d. An integral or attached spring that serves to provide force to assist the opening, and, or closing, of the two plier handles relative to one another.
